(19) United States
(12) Patent Application Publication
(10) Pub. No.: US 2025/0275507 A1
(43) Pub. Date: Sep. 4, 2025

(54) BIODEGRADABLE AGRICULTURAL MULCH FILMS FROM COMPOSITIONS OF WASTEPAPER PULP AND CALCIUM ALGINATE AND MANUFACTURING METHODS

(71) Applicant: Louis Zican Huang, MIDLAND, MI (US)

(72) Inventor: Louis Zican Huang, MIDLAND, MI (US)

(73) Assignee: Louis Zican Huang, MIDLAND, MI (US)

(21) Appl. No.: 18/593,928

(22) Filed: Mar. 3, 2024

(51) Int. Cl. A01G 13/02; C08L 5/04

(52) U.S. Cl. CPC A01G 13/33; C08L 5/04; C08L 2312/00

(57) ABSTRACT

Biodegradable agricultural mulch films and methods of making the same are disclosed. The invention pertains to the revelation of biodegradable agricultural mulch films and the techniques employed in their production. These innovative mulch films are composed of a matrix consisting of 5 to 35 weight percent of alginate polysaccharides, coupled with 65 to 95 weight percent of recycled cellulose fibers and wastepaper pulp. What distinguishes these films is the additional bonding (or crosslinking) facilitated by divalent or trivalent ions, thereby enhancing their structural integrity and performance. This combination of materials and bonding mechanisms not only offers a sustainable solution for agricultural practices but also addresses concerns related to environmental degradation and waste management. By utilizing natural and recycled components in the formulation, these mulch films represent a significant stride towards fostering eco-friendly agricultural practices while ensuring efficient crop management and soil conservation.

### FIELD OF THE INVENTION

Embodiments of the present disclosure generally relate to biodegradable agricultural mulch films and applications of agricultural mulch films in a range of end purposes, such as moisture management, temperature regulation, preventing weed seeds from germinating, conserving water, against insects and pests, providing nutrients to the crops, thereby enhancing agricultural productivity and sustainability.

This innovative invention introduces a novel approach to the creation of biodegradable agricultural mulch films, utilizing a blend of wastepaper pulp and alginate biopolymers. Unlike conventional methods that rely on petroleum-based polymers, which lack biodegradability and contribute to environmental pollution, the films produced through this invention offer a sustainable alternative. By combining low-cost wastepaper pulp with biodegradable alginate biopolymers, these films are not only eco-friendly but also economically viable. Crucially, the incorporation of divalent ions, such as calcium ions (Ca²⁺), as detailed in this disclosure, facilitates crosslinking of the wastepaper pulp/alginate films, imparting them with enhanced mechanical strength and durability. This innovative manufacturing process highlights a significant advancement in the development of environmentally sustainable agricultural practices, addressing the pressing need for biodegradable materials while reducing reliance on non-renewable resources. By embracing this approach, agricultural industries can adopt more environmentally friendly practices, contributing to the preservation of ecosystems and the reduction of plastic waste in agricultural environments.

This invention presents detailed descriptions of the composition of biodegradable films, along with comprehensive process steps and methods for their production and utilization. These biodegradable films are specifically engineered for a wide range of applications, with a primary focus on their effectiveness as mulch films. In agricultural settings, these films serve multiple purposes, including the suppression of weeds, conservation of water, and facilitation of plant growth, thereby enhancing crop yields and agricultural productivity. However, the utility of these innovative films extends beyond agriculture, finding potential applications in various other fields such as packaging, construction, and more. Their versatility allows them to address diverse needs across different industries, offering sustainable alternatives to conventional materials while minimizing environmental impact. By leveraging the unique properties of these biodegradable films, users can contribute to the promotion of environmentally friendly practices and the reduction of plastic pollution across various sectors.

### BACKGROUND OF THE INVENTION

Described herein are biodegradable agricultural mulch films, methods of making same, and uses thereof. This invention provides a cost effective, environmentally friendly, and sustainable way to create biodegradable films from wastepaper pulp and sodium alginate, along with the crosslinking chemistry via divalent or multivalent ions.

The challenge of global food security is a complex and pressing issue, intricately connected to the well-being of our planet and the welfare of its burgeoning population, which now exceeds 8 billion individuals. At its core, the challenge revolves around ensuring that everyone has access to an abundant supply of safe and nutritious food to sustain healthy and active lives. Agriculture, which encompasses both crop cultivation and livestock rearing, plays a central role in addressing this challenge. However, the current agricultural landscape faces a myriad of hurdles, ranging from the impacts of climate change to the depletion of water resources, land degradation, and socioeconomic inequalities. These obstacles pose significant threats to the sustainability and resilience of food systems worldwide, underscoring the need for comprehensive and innovative approaches to ensure food security for present and future generations. Addressing these challenges requires concerted efforts from various stakeholders across sectors, including policymakers, researchers, farmers, and communities, to implement solutions that are equitable, sustainable, and resilient in the face of evolving environmental and socio-economic pressures.

The prevalent use of conventional plastic, primarily polyethylene, as mulch films in agriculture stems from its proven effectiveness in weed suppression, water conservation, and promoting plant growth. However, mounting concerns regarding the limited disposal options for these plastics and their reliance on non-renewable resources have catalyzed a growing interest in environmentally friendly alternatives, particularly biodegradable mulches. Biodegradable thermoplastic films, derived from a range of materials including both natural sources and synthetic polymers like starch, poly(lactic acid) (PLA), and poly(vinyl alcohol) (PVOH), offer a promising sustainable substitute for traditional linear low-density polyethylene (LDPE) films. Despite their potential benefits, such as reducing plastic pollution and dependence on fossil fuels, these biodegradable alternatives face challenges related to cost. The current cost disparity between conventional plastics and biodegradable options presents a significant obstacle to their widespread adoption in agricultural practices.

On a yearly basis, the global community contends with a staggering amount of paper and paperboard waste, estimated to range between 400 to 500 million tons. In the context of the United States, statistics from 2018 reveal a substantial contribution to this figure, with the nation generating approximately 67.4 million tons of paper waste alone, constituting around 23% of its total municipal solid waste output. Recycling paper emerges as a sustainable solution with multifaceted benefits, including the conservation of trees, water, and energy resources throughout its lifecycle. Moreover, the repurposing of inexpensive wastepaper into biodegradable mulch films serves as a proactive measure against landfill accumulation and the associated greenhouse gas emissions. Beyond waste reduction, this approach holds significant implications for advancing global food security initiatives by offering sustainable alternatives while concurrently championing environmental stewardship principles. By diverting paper waste towards productive agricultural applications, society not only mitigates environmental harm but also contributes to the creation of a more resilient and sustainable food production system, aligning with broader efforts towards achieving global sustainability goals.

The susceptibility of paper pulp to water necessitates a strategic approach involving the integration of other biodegradable materials to engineer functional mulch films. One such material, sodium alginate, derived from seaweeds, emerges as a key component due to its unique properties. Acting as a polymer, sodium alginate enables the formation of biopolymeric films crucial for various applications. Structurally, it comprises a linear, unbranched chain characterized by β-(1,4)-linked D-mannuronic acid (M) and α-(1,4)-linked L-guluronic acid (G) units. Found naturally in the cell walls of marine brown algae, sodium alginate typically consists of 30 to 60% alginic acid. The conversion of alginic acid to sodium alginate renders it water-soluble, streamlining its extraction process and enhancing its versatility for integration into mulch film formulations. This amalgamation of paper pulp with sodium alginate represents a strategic synergy, harnessing the unique properties of both materials to create robust and environmentally friendly solutions for diverse applications in agriculture and beyond.

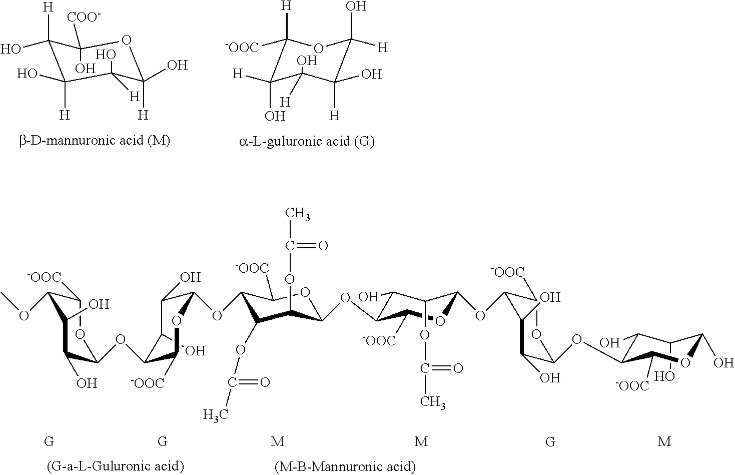

Alginate, characterized by its exceptional transparency, uniformity, and effective oxygen barrier properties, represents a notable material in various applications. However, its inherent hydrophilic nature poses challenges due to susceptibility to water permeation. This characteristic places it within the category of polyuronates, alongside other natural ionic polysaccharides, with alginate being particularly prone to chain-chain associations. Upon exposure to divalent cations such as calcium ions (Ca2+), alginate forms crosslinked hydrogels, notably calcium alginate, which exhibit enhanced mechanical strength and water resistance. The integration of sodium alginate with wastepaper pulp through crosslinking chemistry emerges as a promising approach for the development of biodegradable agricultural mulch films. This innovative solution not only addresses the crucial requirements of mechanical integrity and water resistance but also aligns with evolving market demands for sustainable and environmentally friendly materials. Through this novel integration, alginate's inherent properties are leveraged to provide a versatile and eco-friendly solution to contemporary challenges in film manufacturing and agricultural practices.

### SUMMARY OF THE INVENTION

In certain embodiments, the invention described herein relates to a biodegradable agricultural mulch films consisting of, or consisting essentially of: one or more wastepaper pulp and crosslinked alginate polymers, wherein said matrix consists of 5 to 35 weight percent alginate polysaccharides and 65 to 95 weight percent recycled cellulose fibers or wastepaper pulps. Through this formulation, the mulch films exhibit environmentally friendly characteristics, as they can degrade naturally over time, minimizing the environmental impact associated with traditional plastic mulches. By utilizing recycled materials and biodegradable polymers, this innovation aims to address sustainability concerns within agricultural practices while providing effective weed control and moisture retention benefits for crop cultivation.

In an embodiment, there is disclosed a method of forming biodegradable agricultural mulch films, said method steps comprising, consisting of, or consisting essentially of:
a) providing a composite formulation comprising: (i) 65-95 wt % of one or more wastepaper pulp and (ii) 5-35 wt % of alginate polymers crosslinked by bivalent or multivalent ions;
b) forming a hydrogel film from a solution of wastepaper pulp and water-soluble alginate polymer;
c) subjecting the hydrogel film to a solution of 1-50 wt %, preferably 3-10 wt %, bivalent or multivalent ions, followed by drying to remove water; thereby producing a biodegradable agricultural mulch film.

In certain embodiments, the method outlined represents a continuous process designed for the production of biodegradable agricultural mulch films. This method unfolds through a series of steps, commencing with the utilization of one or more extruders to facilitate the dissolution of sodium alginate within water, subsequently blending it with wastepaper pulp under elevated temperature conditions. Following this initial mixing stage, the resultant mixture undergoes further processing by being passed through a die, shaping it into the desired film form. To impart stability and enhance biodegradability, the formed film is immersed in a calcium chloride (CaCl₂)) solution, triggering crosslinking reactions that reinforce its structure. Subsequently, the treated films are subjected to a drying phase within an oven, culminating in the formation of robust and environmentally friendly biodegradable films suitable for agricultural applications. This method's continuous nature offers efficiency and scalability, catering to the demand for sustainable alternatives in modern farming practices while ensuring the effective management of weed growth and moisture retention crucial for crop cultivation.

### BRIEF DESCRIPTION OF THE DRAWINGS

The accompanying drawings, presented to enhance comprehension of the invention, are integrated within and form an integral part of this specification. These illustrations depict various embodiments of the invention and, in conjunction with the description provided, elucidate the underlying principles of the invention. In the drawings:

FIG. 1 is an illustration of a small-scale process for making wastepaper pulp/alginate biodegradable agricultural mulch films.

FIG. 2 shows the effect of sodium alginate/wastepaper pulp composition on the formation of biodegradable agricultural mulch films.

FIG. 3 gives the tensile strength of wastepaper pulp/alginate biodegradable agricultural mulch films with/without the treatment of CaCl₂) solution.

FIG. 4 shows the field-testing results of wastepaper pulp/alginate mulch films, covering a garden pot with Chives for 1 month, 3 months and 5 months.

FIG. 5 is an illustration of a large-scale manufacturing process for producing wastepaper pulp/alginate biodegradable agricultural mulch films.

### DETAILED DESCRIPTION OF THE INVENTION

A deeper understanding of the present invention can be gleaned from the detailed description, examples, drawings, and claims provided herein, as well as their preceding and subsequent context. However, it should be noted that the scope of this invention is not confined to the specific compositions, articles, devices, systems, and/or methods disclosed unless explicitly stated otherwise, and may naturally vary. Although certain aspects of the present invention may be described and claimed within a particular statutory class, such as the composition of matter statutory class, this classification is for convenience only. Those skilled in the art will recognize that each aspect of the present invention can be described and claimed within any applicable statutory class.

The following exposition of the invention serves as an instructive guide to its optimal, current manifestation. In this regard, individuals possessing ordinary skill in the pertinent field will acknowledge the potential for alterations and enhancements to the various facets of the invention outlined herein, while still achieving favorable outcomes. It is evident that certain advantages of the present invention can be attained by selectively incorporating specific features without necessitating the inclusion of others. Hence, practitioners in the relevant domain will appreciate the feasibility and potential benefits of numerous modifications and adaptations to the present invention, which may prove advantageous under certain circumstances, thereby constituting integral aspects of the invention.

Although the present invention can take on diverse forms, the description below outlines several embodiments with the acknowledgment that this disclosure serves as an illustration of the invention, rather than a restrictive definition. The intention is not to confine the invention to the specific embodiments depicted. Headings are included solely for convenience and should not be interpreted as limitations on the scope of the invention. Embodiments presented under any heading or section of the disclosure are interchangeable and can be combined with embodiments from other sections as deemed appropriate.

The invention encompasses any combination of the elements described herein in all conceivable variations, unless explicitly indicated otherwise in this document or contradicted by the surrounding context.

Unless expressly stated otherwise, no method or aspect described herein should be interpreted as mandating a specific order of execution for its steps. Therefore, unless explicitly mentioned in the claims or description of a method, there is no intent for any particular order to be inferred. This applies to any possible interpretation basis, including logical sequence of steps, grammatical structure, punctuation, or the variety of embodiments detailed in the specification. It should be noted that both the preceding general overview and the subsequent detailed explanation are provided as examples and clarifications only, without imposing restrictions.

All publications mentioned herein are incorporated herein by reference to disclose and describe the methods and/or materials in connection with which the publications are cited.

The terminology employed herein serves the purpose of describing specific aspects and is not meant to impose limitations. Unless otherwise specified, all technical and scientific terms used in this document carry the same meaning as understood by individuals with ordinary skill in the relevant field. Throughout this specification and in the ensuing claims, several terms will be referenced, many of which are defined within the text.

In this specification and in the attached claims, the singular forms “a,” “an,” and “the” encompass plural references unless the context unmistakably indicates otherwise.

In this context, the term “and/or” signifies “and,” “or,” or both, as an alternative.

In this context, the terms “optional” or “optionally” indicate that the event, condition, component, or circumstance subsequently described may or may not take place. The description encompasses scenarios where the said event, condition, component, or circumstance occurs, as well as scenarios where it does not.

In this context, any disclosures employing the terms “comprises” or “comprising” also encompass a comparable disclosure, wherein “comprises” or “comprising” is substituted with “consists” or “consisting”, or alternatively replaced with “consists essentially of” or “consisting essentially of”.

In this context, the phrase “sufficient to” (e.g., “conditions sufficient to”) denotes a value or condition capable of fulfilling the function or property specified by the expressed sufficiency. As elaborated later, the precise value or specific condition needed may differ among various embodiments, influenced by factors such as the materials utilized and/or the processing conditions.

When the term “by weight” is used in relation to a component, it is presumed, unless explicitly stated otherwise, to be based on the total weight of the formulation or composition containing that component. For instance, if a specific element or component in a composition or article is noted to be present at 5% by weight (also denoted as 5 wt %), it signifies that this percentage is in reference to the total compositional percentage of 100%. The weight percentage (wt %) of component A in a composition represents the weight of component A expressed as a percentage of the total weight of the composition, typically indicated as “wt % of A, based on the total weight of the composition”. In certain cases, the weight percent of a component is assessed based on the total weight of the composition “on a dry basis,” which denotes the weight of the composition excluding water (e.g., less than about 1%, less than about 0.5%, less than about 0.1%, less than about 0.05%, or approximately 0% of water by weight, based on the total weight of the composition).

When presenting numerical values in this document, such as 1, 2, 3, 4, 5, 6, 7, 8, 9, 10, the subsequent statement typically follows: “Each of the aforementioned numbers can be preceded by the term ‘about,’ ‘at least about,’ or ‘less than about,’ and any of them can be used individually to define an open-ended range or collectively to specify a closed-ended range.” This statement indicates that each of these numbers can be utilized as standalone values (e.g., 3), preceded by the term “about” (e.g., about 5), prefaced with “at least about” (e.g., at least about 3), introduced with “less than about” (e.g., less than about 6), or employed in any combination, with or without these preceding terms, to delineate a range (e.g., 2 to 9, about 1 to 4, 8 to about 9, about 1 to about 10, etc.). Additionally, when a range is described as “about X or less,” it's equivalent to a combination of “about X” and “less than about X” interchangeably. For instance, “about 10 or less” equals “about 10, or less than about 10.” Such interchangeable descriptions of ranges are contemplated in this document. While other formats for ranges are presented herein, differences in format should not be construed as differences in substance.

In this context, “continuous” refers to a process that proceeds without interruption throughout its entirety, or if there are any interruptions, pauses, or suspensions, they are brief compared to the overall duration of the process. A process is considered “continuous” when the starting materials or reactants are supplied to the apparatus without interruption or with only minor interruptions, and the pressing of these materials is not carried out in a batch fashion.

In this document, the phrase “substantially free of” denotes a composition containing less than 1% by weight of the specified material. This can include quantities lower than about 0.5%, less than 0.1%, less than about 0.05%, or even less than 0.01% by weight, relative to the total weight of the composition.

In this context, the term “substantially,” when referring to a composition, denotes a proportion of at least about 60% by weight. This could include percentages such as at least about 65%, 70%, 75%, 80%, 85%, 90%, 91%, 92%, 93%, 94%, 95%, 96%, 97%, 98%, 99%, or even 100% by weight, relative to the total weight of the composition, concerning a specified feature or component.

The quantities of individual ingredients or their combinations as described subsequently may collectively constitute up to 100% of the total ingredient content in the composition. All percentages, parts, and ratios are calculated based on the total weight of the compositions within this invention, unless explicitly stated otherwise. Regarding listed ingredients, their weights are determined based on the active level, excluding any carriers or by-products that might be present in commercially available materials. Unless specified otherwise, the levels of components or compositions refer solely to their active portion, excluding impurities such as residual solvents or by-products that could be present in commercially sourced components or compositions.

In this context, the term “biodegradable” typically denotes a material's capacity to undergo chemical decomposition in specific environmental settings. Biodegradability represents an inherent characteristic of the material, and its degree can vary based on the particular environmental conditions it encounters.

In this document, the term “recyclable” pertains to a broad category of used paper, encompassing both in-plant waste generated during manufacturing processes and post-consumer waste discarded by end-users. These materials possess the inherent capability to undergo processing procedures outlined in the Voluntary Standard for Repulping and Recycling Corrugated Fiberboard, with enhancements tailored to improve its performance in environments involving water and water vapor, as delineated in the specifications dated Aug. 16, 2013. Thus, “recyclable” denotes not only the potential for repulping but also the suitability for transformation into new products, aligning with established industry standards aimed at sustainable resource management and environmental conservation.

Within this context, the term “film” encompasses a structural entity characterized by its non-fibrous composition and possessing a defined three-dimensional configuration, delineated by its thickness, length, and width. The criteria for classification as a “film” include specific aspect ratios: both the length-to-thickness and width-to-thickness ratios must be maintained at a minimum of approximately 5:1. Additionally, the length-to-width ratio is expected to meet a threshold of at least about 1:1. Alternatively, these aspect ratios may adhere to more stringent parameters, with the length-to-thickness and width-to-thickness ratios being at least 10:1 or possibly 15:1, and in some cases even extending to 20:1. Correspondingly, the length-to-width aspect ratio might be adjusted to be at least approximately 1.2:1, 1.5:1, or in certain instances, as high as 1.618:1. These specifications collectively define the characteristics of a “film,” illustrating its geometric proportions and aiding in its distinct categorization within various applications and industries.

In the context provided, the term “water-soluble” denotes the property of a given sample material to undergo complete dissolution or dispersion when subjected to water, resulting in the absence of any discernible solids or the formation of separate phases. This dissolution process is rigorously defined by specific conditions: when a minimum quantity of the sample material, typically starting at around 25 grams per liter of deionized water, is introduced into the solvent at a temperature of 20° C. under standard atmospheric pressure, and subjected to adequate stirring to facilitate homogeneity. Alternatively, the requirement may escalate to higher quantities, such as 50 grams, 100 grams, or even 200 grams of the material per liter of water, ensuring a robust evaluation of its water solubility characteristics across varying concentrations. By adhering to these standardized protocols, the term “water-soluble” establishes a precise criterion for assessing the dissolution behavior of materials, thereby enabling consistent and reliable interpretation within scientific, industrial, and regulatory contexts.

The term “cellulose fiber” encompasses a broad range of materials, including both virgin fibers and those derived from waste or recycled sources, providing flexibility in material selection. These fibers may exhibit fibrillation, characterized by the formation of fibrils within the fiber structure, or remain non-fibrillated depending on the desired properties of the end product. In the context of biodegradable agricultural mulch films, cellulose fibers serve as one of the essential ingredients, contributing to the film's structural integrity and biodegradability. These fibers are sourced from various cellulose-rich materials, such as plants, and encompass the unbranched polymer D-glucose (anhydroglucose) obtained from these sources. Cellulose and its derivatives may also contain hemicellulose and lignin, further diversifying their composition and properties. At a microscopic level, individual cellulose polymer chains associate to form thicker microfibrils, which then aggregate to form fibrils arranged into bundles. These bundles, visible under high magnification using light or scanning electron microscopes, represent the fibrous components of plant cell walls. Understanding the intricate structure and composition of cellulose fibers is crucial for optimizing their utilization in biodegradable mulch films, ensuring the films meet desired performance standards while aligning with sustainable material sourcing practices.

Hemicellulose, within the context of wood composition, represents a diverse and heterogeneous group of low molecular weight carbohydrate polymers that are intimately associated with cellulose fibers. Unlike cellulose, which forms linear polymer chains, hemicelluloses typically exhibit branched structures, contributing to the complexity and variability of their properties. These polymers are comprised of a variety of simple sugars, including D-glucose, D-xylose, D-mannose, L-arabinose, D-galactose, D-glucuronic acid, and D-galacturonic acid, which combine to form the intricate molecular structures characteristic of hemicelluloses. The presence of hemicellulose alongside cellulose in wood plays a crucial role in the structural integrity and functionality of plant cell walls, influencing properties such as flexibility, strength, and water absorption. Moreover, the diverse composition of hemicelluloses offers potential for various industrial applications, including as renewable resources for biofuel production, food additives, and pharmaceutical excipients.

Lignin, a complex aromatic polymer, is a significant constituent of wood, constituting approximately 20% to 40% of its composition in an amorphous form. It can be classified into three main classes: softwood or coniferous lignins, hardwood lignins, and grass or annual plant lignins, each exhibiting distinct characteristics based on their botanical origins. Softwood lignins primarily derive from coniferyl alcohol or guaiacylpropane monomers, imparting specific properties to coniferous trees. In contrast, hardwood lignins encompass polymers of 3,5-dimethoxy-4-hydroxyphenylpropane monomers alongside guaiacylpropane monomers, contributing to the diverse structural complexity observed in hardwood species. Grass lignins present yet another variation, containing polymers of both guaiacylpropane and 3,-5-dimethoxy-4-hydroxyphenylpropane monomers, along with 4-hydroxyphenylpropane monomers. Notably, hardwood lignins exhibit greater structural heterogeneity across different species compared to softwood lignins, reflecting variations in their molecular composition and organization.

There are two main classifications of wastepaper pulp, any or both of which can be used as a source of cellulose fiber in the composition for biodegradable agricultural mulch films:

(i) pre-consumer waste: Pre-consumer waste encompasses a diverse array of materials, including offcuts and processing waste like guillotine trims and discarded envelope blanks. This category of waste originates outside the paper mill environment and carries the risk of being disposed of in landfills if not properly managed. However, it represents a genuine source of recycled fiber, thereby contributing to sustainable practices within the paper industry. Moreover, it encompasses de-inked pre-consumer materials, referring to recycled items that have undergone printing processes but have not reached their intended end-use, such as excess printed materials from printers or unsold publications. By incorporating these materials into the recycling process, pre-consumer waste effectively falls under the umbrella of waste/recycle pulp, playing a vital role in the circular economy and resource conservation efforts within the paper manufacturing sector.

(ii) Postconsumer waste: Postconsumer waste constitutes a significant portion of recycled fiber, comprising paper that has fulfilled its intended purpose and has been used by end consumers. This category encompasses a wide range of materials, including office waste, magazine papers, and newsprint, which have served their initial functions and are now available for recycling. Given that the majority of postconsumer waste is printed, whether through digital methods or traditional techniques such as lithography, offset, or rotogravure, it typically undergoes a de-inking process as a preliminary step in the recycling process. This de-inking process aims to remove ink and other contaminants from the paper fibers, allowing for the production of high-quality biodegradable agricultural mulch film products. Thus, postconsumer waste plays a crucial role in the waste/recycle pulp, contributing to the closed-loop system of paper recycling and promoting sustainability in the paper industry.

The potential sources of wastepaper pulp containing cellulosic fiber for the production of biodegradable agricultural mulch films are diverse and expansive, offering flexibility in material selection. These sources may encompass a blend of conventional fibers, derived from both virgin pulp and waste/recycled sources, as well as high coarseness lignin-rich tubular fibers. Examples of such fibers include bleached chemical thermomechanical pulp (BCTMP), thermomechanical pulp (TMP), Chemithermomechanical pulp (CTMP), alkaline peroxide mechanical pulp (APMP), and groundwood pulp (GWP), which can be utilized in both bleached and unbleached forms, and deinked as necessary. Additionally, these pulps may undergo chemical processing via the Kraft method to produce Kraft pulps (both sulfate and sulfite) and bleached Kraft pulps. In the case of recycled pulps, bleaching may or may not have occurred during the recycling process. Any of the aforementioned pulps that have not undergone prior bleaching treatments can be subjected to bleaching procedures outlined herein to yield bleached pulp materials, ensuring consistency and quality in the production of biodegradable mulch films. This wide array of potential pulp sources underscores the versatility and adaptability of the manufacturing process, enabling the utilization of various raw materials while maintaining the desired properties and characteristics essential for the production of high-quality agricultural mulch films.

The pulp can be further processed in a pulp mill to remove additional impurities through washing, screening, and subjected to additional defibering or de-knotting.

Depending on the method of processing, whether mechanical or chemical, the pulp can undergo bleaching treatments to achieve desired levels of brightness and purity. Various chemical agents may be employed for bleaching purposes, including chlorine, chlorine dioxide, oxygen, peracids, sodium hypochlorite, hydrogen peroxide, alkaline peroxide, among others. Particularly, the use of oxygen in the bleaching process is often preferred, aiming to minimize environmental impact and avoid the potential hazards associated with chlorine-based bleaching methods. Bleached pulp that has been processed without the use of elemental chlorine or hypochlorite is commonly referred to as Elemental Chlorine Free (ECF), signifying a commitment to environmentally responsible production practices. For even greater environmental stewardship, mills may opt for a more stringent bleaching sequence known as Totally Chlorine Free (TCF), which eliminates the use of chlorine compounds entirely. This advanced bleaching process underscores a dedication to sustainability and aligns with regulatory and consumer preferences for eco-friendly products. By adopting ECF or TCF bleaching methods, manufacturers demonstrate their commitment to reducing environmental impact and promoting sustainable practices throughout the pulp and paper production chain.

In addition to wastepaper pulp, various fibrous materials can be incorporated into the composition to enhance the flexibility and prevent brittleness of films produced from it. These fibrous materials encompass a diverse range of sources, including particulated cellulose fibers derived from agricultural residues such as sugar-cane residues, corn stover, and sugar beet residues, as well as coconut husk (coir dust), cotton linters, citrus residues, and sawdust. Additionally, particulated fibers prepared from coagula or extruded fibers of water-insoluble biopolymers, such as calcium alginate, serve as suitable additives to improve film properties. Representative sources of cellulose fibers extend beyond wood to include various non-wood plants rich in cellulose content, such as soy, rice, cereal straw, flax, bamboo, reeds, esparto grass, jute, fax, sisal, abaca, hemp, bagasse, kenaf, Sabai grass, milkweed floss fibers, pineapple leaf fibers, switch grass, and lignin-containing plants, among others. These cellulose fibers may be sourced from virgin materials, waste/recycled cellulose fiber, or a combination thereof, offering versatility in material selection. By blending hardwood and softwood fibers, manufacturers can tailor the properties of the resulting article to achieve specific characteristics such as strength, whiteness, or writing surface quality. The diverse and mixed characteristics of recovered fibers render them particularly well-suited for a range of applications, including packaging materials and the production of biodegradable agricultural mulch films. Biodegradable agricultural mulch films can be made from 100% recycled materials or blended with virgin pulp.

The molecular structures of alginates have undergone millions of years of evolution, finely tuned to support the growth and survival of brown algae. These algae, abundant in alginates, boast remarkable characteristics; they are not only among the fastest-growing organisms on Earth but also stand out as the longest and heaviest of all seaweeds. This unique feature enhances the accessibility of alginates and subsequently contributes to lowering its production cost. Extraction of alginate, typically found in the form of sodium salt, involves heating algae in a hot soda (Na₂CO₃) solution. Alginate, also known as alginic acid, presents as a copolymer comprising 1→4 linked β-D-mannuronic acid (M) and α-L-guluronic acid (G) residues. The varying compositions and sequences of M and G monoblocks within alginates result in a wide array of physical and biological properties, finely tuned in brown algae to suit specific environmental conditions, subject to fluctuations due to seasonal and growth variations. For instance, coastal algae exhibit higher G content compared to those thriving in streaming waters, imparting greater rigidity to alginate gels. The presence of multivalent ions from seawater further reinforces the matrix, augmenting the plant body's structural integrity. Alginates produced by different algae species and bacteria exhibit diverse G-M compositions and monoblock lengths. Moreover, enzymatic post-modification offers a means to alter the alginate composition, rendering it an exceedingly versatile substance with myriad applications.

Alginate, a polysaccharide derived from alginic acid salts, serves as a linear compound naturally synthesized by brown seaweeds, boasting a molecular architecture crucial for various applications. The alginate employed in this particular context typically comprises chains containing anywhere from 100 to 3000 monomer units intricately linked together, thus forming a remarkably flexible structure. Within these chains, the monomers manifest in two primary forms: β-(1,4)-linked D-mannuronic acid (M) residues and α-(1,4)-linked L-guluronic acid (G) residues. It's worth noting that under physiological pH conditions, the carboxylic acid group of each monomer within the polymer undergoes ionization, contributing to the compound's distinctive properties. These M and G residues, although structurally similar, are epimers, differing solely in stereochemistry at the C5 position. Typically, within the alginate polymer, the residues are arranged in blocks of identical or strictly alternating patterns, such as MMMMM . . . , GGGGG . . . , or GMGMGM . . . . Various monovalent and polyvalent cations can serve as counterions to the negatively-charged carboxylate groups of the D-mannuronic acid and L-guluronic acid residues in the alginate polymer. Generally, the film contains an alginate salt where the counterions are monovalent cations. These counterions within a single alginate polymer molecule may be uniform or diverse. Preferably, the counterions are chosen from Na⁺, K⁺, and NH₄⁺. Specifically, Na⁺ is preferred. Alternatively, the film might comprise a blend of alginate salts, including at least one alginate salt with a monovalent cation. This mixture could encompass alginate salts with cations like Na⁺, K⁺, and NH₄⁺. The film may consist solely of the alginate salt of a monovalent cation or a combination of alginate salts containing at least one such monovalent cation. Alternatively, the film could incorporate one or more additional film-forming agents alongside the alginate salt of a monovalent cation or its mixture.

The biodegradable agricultural mulch film is composed of an alginate formulation with an average guluronate (G) content ranging from 65 to 75% by weight and an average mannuronate (M) content ranging from 25 to 35% by weight. Thus, the film contains an alginate composition with a mean guluronate (G) content falling within the 65 to 75% range by weight, and a mean mannuronate (M) content within the 25 to 35% range by weight. Ideally, the film incorporates an alginate composition with a mean molecular weight between 30,000 g/mol and 90,000 g/mol, with options including 35,000 g/mol to 85,000 g/mol, 40,000 g/mol to 70,000 g/mol, or even 40,000 g/mol to 50,000 g/mol. Most preferably, the film consists of an alginate composition with a mean guluronate (G) content of 65 to 75%, a mean mannuronate (M) content of 25 to 35%, and a mean molecular weight ranging from 30,000 g/mol to 90,000 g/mol.

Typically, the biodegradable agricultural mulch film comprises from 1% to 99% by weight of the alginate salt of a monovalent cation or the mixture of alginate salts containing at least one alginate salt of a monovalent cation, preferably from 5% to 75% by weight, more preferably from 5% to 50% by weight, still more preferably from 10% to 35% by weight, and most preferably from 10% to 20% by weight.

In certain instances, biodegradable agricultural mulch films are constructed using water-soluble biodegradable polymers carefully chosen from a range of options. These polymers, including but not limited to polyvinyl alcohol, polyethylene oxide, methylcellulose, sodium alginate, and combinations thereof, play a pivotal role in creating environmentally friendly solutions for agricultural practices. Particularly in scenarios where the goal is to achieve a “plastic-free” product, there's a deliberate selection of water-soluble, naturally derived polymers like sodium alginate. This choice not only aligns with sustainability objectives but also underscores a commitment to utilizing renewable resources in agricultural settings. By incorporating sodium alginate, derived from seaweed, into the formulation of mulch films, the resulting product demonstrates biodegradability while still offering the necessary functionality for agricultural applications. This strategic decision reflects a growing awareness of the need to mitigate plastic pollution and transition towards more eco-conscious alternatives in various industries, including agriculture. In one embodiment, the biodegradable agricultural mulch film comprises from 0.1% to 15% by weight of water-soluble biodegradable polymers besides sodium alginate, preferably from 0.5% to 10% by weight, more preferably from 0.5% to 1% by weight.

In certain applications, it may become necessary for biodegradable films, especially those that are water-soluble, to incorporate disintegrants to enhance their dissolution rate in water. A variety of disintegrants are considered suitable for this purpose, including but not limited to corn or potato starch, methyl celluloses, mineral clay powders, croscarmellose (cross-linked cellulose), crospovidone (cross-linked polyvinyl N-pyrrolidone, or PVP), and sodium starch glycolate (cross-linked starch). These disintegrants play a crucial role in breaking down the film structure upon contact with water, facilitating rapid dissolution and subsequent dispersal. The inclusion of water-soluble polymers, comprising between 0.1% and 15% by weight of disintegrants and preferably comprising between 0.2% to 0.5% by weight of disintegrants, further enhances the disintegration process.

Biodegradable agricultural mulch films, when necessary, can include various plasticizing agents to improve their properties, such as flexibility and durability. These agents encompass a wide range of compounds like fatty acids (oleic acid, palmitic acid), dioctyl phthalate, phospholipids, polyethylene glycol, glycerine, salts, saccharides (sucrose), and more, allowing for tailored modifications to meet specific application requirements. The quantity of plasticizer component, ranging from 0.01% to 10% of the film's dry weight, can vary based on needs, with typical concentrations falling between 0.2% and 1%. Water-soluble plasticizers may be chosen from polyols (glycerol, ethylene glycol) and sugar alcohols (sorbitol, mannitol). Alternatively, less mobile plasticizers like sorbitol or polyethylene oxide may enhance barrier properties compared to more mobile options like glycerol. In cases prioritizing natural materials, alternatives such as vegetable oil, polysorbitol, mineral oil, sucrose, and natural gums can be utilized.

In certain instances, biodegradable agricultural mulch films may include surfactants to enhance their properties. These surfactants can belong to various classes such as non-ionic, cationic, anionic, or zwitterionic. Suitable options encompass a broad range of compounds including poloxamers, alcohol ethoxylates, alkylphenol ethoxylates, tertiary acetylenic glycols, alkanolamides, polyoxyethylene amines, quaternary ammonium salts, quaternized polyoxyethylene amines, amine oxides, N-alkylbetaines, sulfobetains, dioctyl sodium sulfosuccinate, lactylate fatty acid esters of glycerol and propylene glycol, lactylated fatty acid esters of glycerol and propylene glycol, lactylic esters of fatty acids, sodium alkylsulfates, polysorbate 20, polysorbate 60, polysorbate 65, polysorbate 80, lecithin, acetylated fatty acid esters of glycerol and propylene glycol, acetylated esters of fatty acids, and various combinations thereof. The biodegradable agricultural mulch film may contain surfactants ranging from 0.1% to 2.5%, alternatively from about 0.2% to about 0.5% by weight, contributing to improved performance and functionality.

In some embodiments, biodegradable agricultural mulch films offer a versatile platform for incorporating various additives to enhance their performance and functionality. Among these additives are fillers, extenders, anti-blocking agents, de-tackifying agents, and colorants, each serving specific purposes to meet diverse application requirements. Fillers and extenders, such as starches, modified starches, crosslinked polyvinylpyrrolidone, crosslinked cellulose, microcrystalline cellulose, silica, metallic oxides, calcium carbonate, talc, and mica, are commonly utilized to improve film properties such as strength, stiffness, and dimensional stability. Anti-blocking agents and de-tackifying agents play a crucial role in preventing the adhesion of film surfaces, ensuring easy handling and processing. Additionally, colorants, including organic and inorganic pigments like titanium dioxide (white), iron oxide (red, yellow, brown), and natural dyes derived from sources such as beetroot (red) or spirulina (blue-green), may be incorporated to impart visual appeal or facilitate product identification. The quantity of these additives can vary, typically ranging from 0.1% to 25% by weight, with alternative concentrations falling between about 0.5% and about 2%, depending on specific formulation requirements and desired film characteristics.

In certain instances, biodegradable agricultural mulch films may incorporate antifoams to address potential issues related to foam formation during film production or application. Antifoams serve to suppress foam formation and stabilize the film-forming process, ensuring consistent quality and performance. Suitable antifoams for this purpose include a variety of compounds such as polydimethylsiloxane and hydrocarbon blends, which are known for their effectiveness in reducing foam levels. These antifoams are carefully selected to meet the specific requirements of agricultural mulch films while minimizing any adverse effects on film properties or environmental impact. The quantity of antifoams incorporated into the film formulation can vary, typically ranging from 0.001% to 0.5% by weight. Alternatively, concentrations may fall within the range of about 0.01% to about 0.1%, depending on factors such as foam severity and desired film characteristics.

In certain scenarios, biodegradable films may contain lubricants or release agents to facilitate processing and improve product performance. These agents, which serve to reduce friction and enhance release properties, encompass a range of compounds including fatty acids and their salts, fatty alcohols, fatty esters, fatty amines, fatty amine acetates, fatty amides, and various combinations thereof. The inclusion of such lubricants/release agents in the film formulation can significantly improve handling during manufacturing and application processes, ensuring smoother operations and minimizing the risk of product sticking or adhesion. Typically, the concentration of these agents in the biodegradable films ranges from 0.02% to 1.5% by weight. Alternatively, concentrations may fall within the range of about 0.1% to about 0.3%, depending on specific formulation requirements and desired film characteristics.

In addition to its primary components, the biodegradable agricultural mulch film may incorporate antioxidants to enhance its stability and longevity in agricultural environments. Antioxidants, defined as compounds that inhibit the oxidation of other chemical species, play a crucial role in preventing degradation and extending the lifespan of the film. A variety of antioxidants are suitable for this purpose, including but not limited to ascorbic acid, citric acid, sodium bisulfite, sodium metabisulfite, ethylenediaminetetraacetic acid (EDTA), butyl hydroxitoluene, and various combinations thereof. Preferably, the chosen antioxidant is either ascorbic acid, sodium bisulfite, or a combination of both, with a preference towards ascorbic acid due to its effectiveness in combating oxidation. Ideally, the film formulation includes both ascorbic acid and sodium bisulfite as antioxidants, providing comprehensive protection against oxidative damage. The concentration of antioxidants in the film typically ranges from 0.001% to 4% by weight for each antioxidant present, with a narrower range of 0.001% to 0.1% by weight for optimal effectiveness.

In addition to its primary constituents, the biodegradable agricultural mulch film commonly integrates antimicrobial agents to combat microbial growth and maintain product integrity. These antimicrobial agents, defined as compounds capable of either killing microorganisms or inhibiting their growth, serve a crucial role in preserving the quality and hygiene of the film. Various antimicrobial agents are suitable for this purpose, encompassing compounds such as benzyl alcohol, benzalkonium chloride, benzoic acid, methyl-, ethyl-, or propylparaben, and quaternary ammonium compounds, among others. The selection of antimicrobial agents depends on factors such as efficacy, compatibility with film materials, and environmental considerations. Ideally, the film formulation contains a balanced combination of antimicrobial agents, ensuring broad-spectrum protection against microbial contamination. The concentration of antimicrobial agents typically ranges from 0.001% to 4% by weight for each agent present, with a preferred range of 0.001% to 0.1% by weight to achieve optimal antimicrobial activity while minimizing potential adverse effects.

The terms “ionic polymer,” “anionic polymer,” and “cationic polymer” in this context refer to hydrophilic polymers with uncharged or charged acidic or basic functional groups, often paired with suitable counterions. Examples of suitable anionic polymers include alginates, polyacrylic acid, dextran sulfate, hyaluronic acid, chondroitin sulfate, and dextran phosphate. Cationic polymers encompass substances like chitosan, polyethylenimine, poly-L-lysine, and dimethylaminodextran. Polysaccharide anionic polymers, including alginates, consist of linear copolymers with varying sequences of B-D-mannuronate and α-L-guluronate residues, often found in forms like sodium alginate or calcium alginate. The molecular weight of these alginates typically ranges from 10,000 to 600,000 Daltons. To achieve desired properties such as swellability or mechanical strength, modifications like conversion to acidic groups or cross-linking with divalent cation salts may be necessary, such as through the use of acids like HCl or salts like calcium chloride. The concentration of ionic polymers typically ranges from 0.1% to 3% by weight for each agent present, with a preferred range of 0.1% to 0.4% by weight to achieve optimal swellability and mechanical strength.

Another notable characteristic of sodium alginate is its remarkable ability to undergo ionic exchange with divalent or multivalent ions, such as calcium chloride, leading to the formation of a non-water soluble variant known as calcium alginate. This transformation results in a solid polymer that exhibits unique properties—it is neither hydrophilic nor lipophilic, rendering it entirely impervious to water, moisture, and organic solvent dissolution. In fact, the breakdown of calcium alginate can only be achieved enzymatically, making it highly resistant to conventional digestion methods. Natural enzymes present in soil fungi and mammals possess the necessary capability to digest the complex calcium alginate backbone, highlighting its biodegradability under specific environmental conditions. Examples of divalent ions facilitating this transformation include calcium (Ca²⁺), magnesium (Mg²⁺), copper (Cu²⁺), nickel (Ni²⁺), zinc (Zn²⁺), strontium (Sr²⁺), and barium (Ba²⁺). Multivalent ions, such as aluminum (Al³⁺), iron (Fe³⁺), and also contribute to the process, though specific examples may vary depending on the application and environmental factors. The concentration of divalent or multivalent ions typically ranges from 0.1% to the saturation point, for example, 41.2% for calcium chloride, preferably from 0.5% to 20%, and more preferably from 1% to 10%.

In an alternative embodiment, the incorporation of cross-linking agents such as carrageenan, xanthan gum, and agar into sodium alginate occurs at ratios ranging approximately from 0.1% to 5.0% in relation to 95.0% to 99.9% sodium alginate. This meticulously balanced formulation fosters the development of a sophisticated three-dimensional network structure within the film matrix. Within this network, double helices act as pivotal junction points for polymer chains, facilitating the intricate formation of multiple helix-helix aggregates around the desired molecular compound. This intricate arrangement enhances the film's structural integrity and mechanical properties, offering increased durability and stability. Additionally, the polymeric component may encompass a diverse array of agents, including various crosslinking agents such as cellulose gums, pectins, locust bean gums, and xanthan gums, among others. Furthermore, alternative substances like whey protein gums and agar agar may also contribute to the polymeric composition, further diversifying the film's characteristics and functionalities.

In accordance with the present invention, the biodegradable agricultural mulch films may additionally incorporate a residual water content, contributing to their overall composition and properties. Typically, these films consist of residual water ranging from 0% to 20% by weight. More commonly, the film formulation contains residual water within the range of 5% to 15% by weight, ensuring adequate moisture retention without compromising structural integrity. Ideally, the film comprises a specific percentage of residual water, falling between 9% to 11% by weight, to optimize its performance characteristics. Moreover, in certain embodiments, the film may be formulated to contain approximately 10% by weight of residual water, representing an ideal balance that promotes film functionality and durability. This carefully controlled water content ensures that the film maintains its desired properties, such as flexibility and moisture resistance, while also facilitating appropriate degradation in agricultural environments. Thus, the inclusion of residual water in the film composition underscores its suitability for agricultural applications, providing a sustainable and effective solution for mulching needs.

The end-life product of wastepaper pulp/alginate biodegradable agricultural mulch films offers a sustainable solution beyond their primary use. As these films naturally decompose over time, they break down into organic matter, enriching the soil with beneficial nutrients. This organic material serves as a natural fertilizer, providing essential elements for plant growth and nourishment. When integrated into agricultural practices, such as cultivating crops and vegetables, the decomposed remnants of these films contribute to soil health and fertility. By returning vital nutrients to the earth, including nitrogen, phosphorus, and potassium, the end-life product of wastepaper pulp/alginate biodegradable films supports robust plant growth and enhances crop yields. Moreover, this eco-friendly fertilizer helps maintain soil structure, moisture retention, and microbial activity, fostering sustainable farming practices while minimizing environmental impact. Overall, the utilization of these biodegradable films not only addresses plastic waste concerns but also promotes soil health and agricultural productivity, aligning with the principles of environmental stewardship and sustainable food production.

### Manufacture of Biodegradable Agricultural Mulch Films

The manufacturing process of biodegradable agricultural mulch films, as outlined in the invention, involves a meticulously orchestrated sequence of steps aimed at producing a superior-quality film product. Initially, a film-forming solution is meticulously prepared by adding and thoroughly mixing various constituent components, which may include sodium alginate and wastepaper pulp among others. This solution is then meticulously distributed onto a solid surface, employing techniques such as pouring or spreading to ensure uniform coverage. For instance, the solution can be poured onto the surface and evenly spread using a draw-down blade or similar equipment to achieve consistent distribution. Subsequently, the distributed solution is left to naturally dry on the surface, allowing for the gradual evaporation of water and the formation of a cohesive film structure. This drying phase plays a pivotal role in establishing the desired film thickness and structural integrity, ultimately yielding a biodegradable agricultural mulch film with the requisite properties for effective application in agricultural contexts. Following this, the film undergoes treatment with a solution containing divalent or multivalent ions, achieved through methods such as spraying or immersion. This treatment facilitates crosslinking of the film, enhancing its mechanical properties and durability. The crosslinked film is then subjected to further drying to optimize its characteristics. Through meticulous adherence to these manufacturing protocols, the resulting film products demonstrate heightened functionality and performance, meeting the exacting demands of modern agricultural practices while upholding environmentally sustainable attributes.

A typical method includes the process steps of:
(a) dissolving sodium alginates and other water-soluble constituent components in water under mixing at temperatures between 25° C. and 100° C., preferably between 50° C. and 90° C., more preferably between 60° C. and 80° C., with a concentration of 0.1% to 15%, preferably between 0.5 to 10%, and more preferably between 1% and 5%;
(b) soaking wastepaper pulp (including insoluble constituent components) in water and adding it to the sodium alginate solution, then mixing it with a mechanical stirrer or an extruder; the weight percent of dry wastepaper pulp in the solution ranges from 1% to 50%, preferably from 2% to 30%, more preferably from 5% to 15%.
(c) forming the film by pouring the solution mixture onto a surface, e.g. a plate, preferably a glass or metal plate, and spreading the cast out to the desired thickness, e.g. about 1 mm, typically by means of an applicator, or by extruding through a coat-hanger die with a unfirm die gap to shape the solution mixture into film and cast it onto casting rollers.
(d) crosslinking the film by dipping the film in a solution of divalent or multivalent ions with a concentration between 0.1% and 40%, preferably between 0.5% and 20%, and more preferably between 1% and 10%.
(e) drying the film, typically at a temperature of from 30 to 80° C., and preferably from 40 to 60° C., until the residual water content of the film is from 0 to 20% by weight, preferably from 5 to 15% by weight, and more preferably from 8 to 10% by weight, and a solid film is formed; and
(f) cutting the solid film into pieces of the desired size, and then winding onto a film roll.

### EXAMPLES

### Materials

Wastepaper pulp (bleached) was sourced from Northern West Stuff. Sodium alginate powder (Fit Lane) and calcium chloride (Cape Crystal, E509) were bought from Amazon.

### Procedures for Making Wastepaper Pulp/Alginate Films:

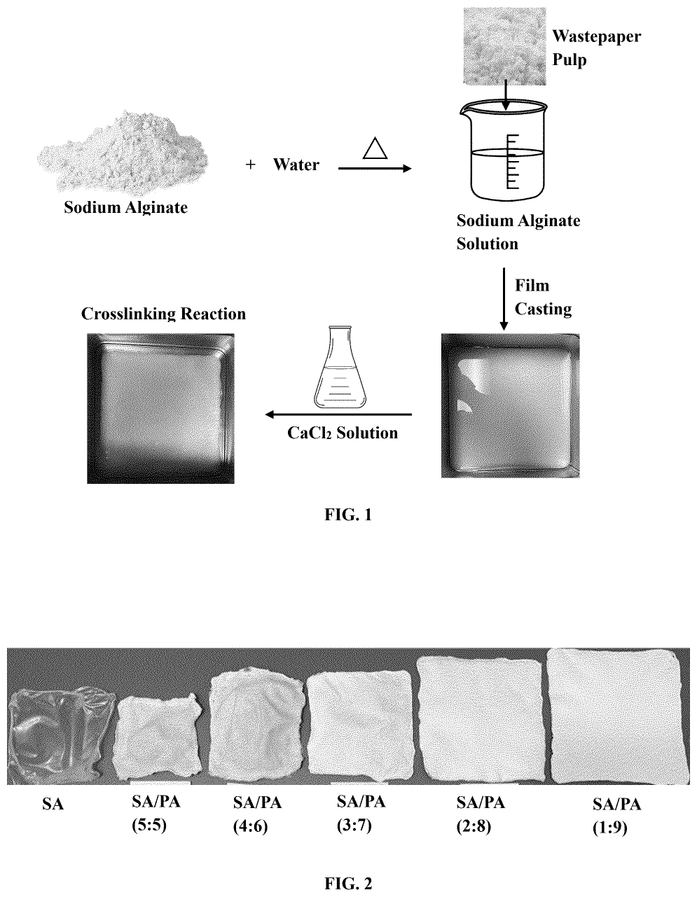

As illustrated in FIG. 1, sodium alginate powder was weighed in a beaker using a balance and then transferred to a beaker. Water was then added to the beaker and a metal spoon was utilized to disperse sodium alginate. A microwave was used to heat the solution temperature to 100° C. After that, a metal spoon was employed to disperse the undissolved particles, and then the microwave was used to reheat the solution again. This procedure was repeated for a few times till sodium alginate is completely dissolved in water. A predetermined amount of wastepaper pulp was weighed and then dissolved in the sodium alginate solution. Then, the mixer was reheated in a microwave and a metal spoon was used to disperse wastepaper pulp in sodium alginate solution. After that, the wastepaper pulp/sodium alginate solution was poured into a metal plate and placed on a flat surface. An electrical fan was employed to accelerate the drying process. After removing most of water, the mixture was turned into a film.

### Procedures for Making Crosslinked Wastepaper Pulp/Alginate Films:

Calcium chloride was weighed and added to a predetermined amount of water in an Erlenmeyer flask with a magnetic stirring bar. The mixture was placed on a magnetic stirring plate, and the solution was stirred till calcium chloride was fully dissolved in water. When the water content in the wastepaper pulp/sodium alginate film was less than 100 grams, the calcium chloride solution was added onto the top of the wastepaper pulp/sodium alginate film. The film was allowed to completely crosslink overnight. After that, the film was taken from the calcium chloride solution, rinsed with pure water, and then placed onto the other dry metal plate surface. An electrical fan was used to further dry the crosslinked film.

### Procedures for the Tensile Test:

Tensile tests were performed on an MTS Insight 5 Tensile Tester following ASTM D638. A minimum of five specimens were tested for each sample. Specimens were punched out evenly across the width of the film using a dogbone-type JDC Precision Sample Cutter. Care was taken to avoid punching out samples near the edges of the film that had the potential to be less uniform. A rate of 5 cm/min was used to pull the specimen. Tensile strength was reported in MPa, along with percent elongation at break.

### Procedures for Fourier Transform Infrared (FTIR) Spectroscopy Measurement:

A Fourier transform infrared spectrometer (Nicolet iS50, ThermoScientific) with a single reflection diamond Attenuated Total Reflectance (ATR) sampling module was used to measure the crosslinking reaction of wastepaper pulp/alginate films. A small specimen was cut from the film, and the FTIR spectrum was obtained at room temperature. Spectral resolution was maintained at 4 cm⁻¹, and the wavelength was set between 400 and 4400 cm⁻¹.

### Procedures for Water Vapor Permeance Measurement:

The wet cup water vapor permeance was determined according to ASTM E96/E96M. Specimens were cut to a diameter of 76.2 mm. The pocket in the dish was filled with distilled water. The specimens were then fitted onto the dish right above the pocket with a metallic plate exposing 63.5 mm diameter of the specimen to the environment. The assemblies were then placed in a controlled chamber operating at a temperature and relative humidity (50±2) %. The assemblies were then weighed periodically. The water vapor permeance data was reported in a unit of g/(24 h·m²).

### Terminology

The sodium alginate to wastepaper pulp weight ratio (abbreviated as SA/PA (x: y), where x and y are numbers. E.g. SA/PA (2:8) indicates that for every 2 grams of sodium alginate there are 8 grams of paper pulp in the solution/film).

### Comparative Example 1

Pure wastepaper pulp is unable to properly form a film. After going through the above film synthesis procedure, only small individual pieces of wastepaper pulp were able to be manufactured. Moreover, pure wastepaper pulp has low structural strength, and is easily saturated with water, making it unsuitable for use as an agricultural mulch film.

### Comparative Example 2

Pure sodium alginate formed a better film than pure wastepaper pulp, but it was extremely brittle, and significant shrinking and warping occurred. In addition, it was not water resistant (in fact, it dissolves in presence of liquid water), but once crosslinked with Ca²⁺, it became water resistant. Furthermore, the crosslinked film exhibited reasonable mechanical strength. However, the problem is that sodium alginate and calcium chloride are multiple times as expensive as wastepaper pulp, making these pure crosslinked alginate films less economically attractive compared to wastepaper pulp/alginate films.

### Comparative Example 3

To make comparative samples of wastepaper pulp/alginate films without the crosslinking treatment with Ca²⁺, wastepaper pulp/alginate solution was directly cast onto a metal plate. An electrical fan was employed to accelerate the drying process for removing liquid water from the sample. In addition, pure alginate film was directly cast from sodium alginate solution (1 wt. %).

### Example 4

At lower CaCl₂) solution concentrations (e.g., 1 wt. %), the wastepaper pulp/alginate films appeared to have weak mechanical strength. In order to simplify the experimental design, all the samples were treated with 5 wt. % CaCl₂) solution for at least 12 hours (overnight) to ensure that the film was fully crosslinked unless otherwise specified.

### Example 5

To fully dissolve sodium alginate in water, excessive water (about 100 g water for 1 g sodium alginate) was added. If 5 wt. % CaCl₂) solution was added right after the solution casting, the film was significantly shrunk in the presence of CaCl₂) solution. It was then decided to remove excessive water from the cast solution before adding CaCl₂) solution for other samples.

### Example 6

The film shrinkage became more and more significant as the loading amount of sodium alginate increased. SA/PA (1:9) and SA/PA (2:8) sample exhibited smooth/flat films without warpage, as given in FIG. 2. Since wastepaper pulp is much cheaper than sodium alginate, these compositions are favorable for producing low-cost mulch films for agricultural applications.

### Example 7

Unlike their precursors (e.g., sodium alginate and wastepaper pulp) that were sensitive to water (e.g., dissolution in water), wastepaper pulp/alginate mulch films could hold liquid water without leakage, upon completion of crosslinking reaction. Water did not show up on the other side of the film after 1 hour.

### Example 8

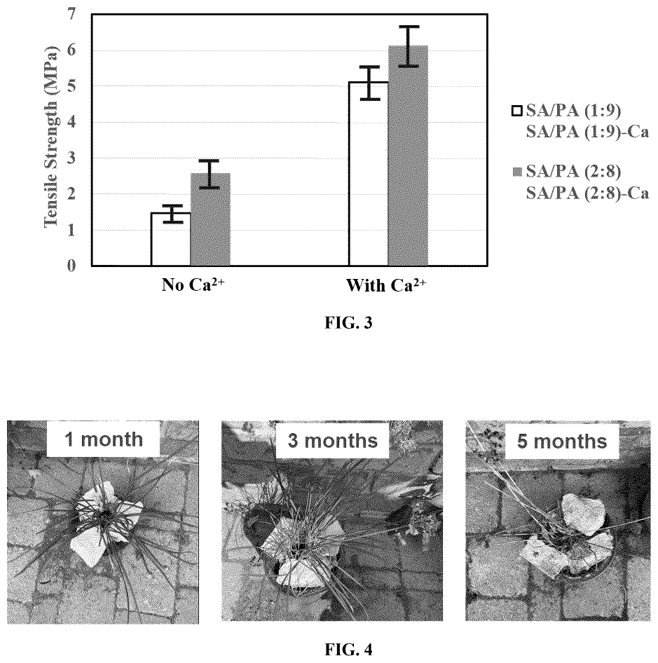

After being crosslinked with calcium chloride, wastepaper pulp/alginate biodegradable films exhibited much higher tensile strength and elongation at break than those without the treatment with CaCl₂) solution. Also, tensile strength of these films increases with increasing sodium alginate content, as given in FIG. 3 and Table 1. Crosslinking significantly increased both the tensile strength and elongation at break of the films. Crosslinked films increased tensile strength by 250% for SA/PA (1:9) and 138% for SA/PA (2:8). For elongation at break, crosslinked SA/PA (1:9) experienced a 95% increase, and SA/PA (2:8) a 97% increase compared to their uncrosslinked counterparts. Furthermore, higher sodium alginate content results in higher mechanical performance, for both tensile strength and elongation at break. Higher tensile strength means a film is more durable, and higher elongation at break means that the film is more flexible and less prone to ripping.

TABLE 1
Tensile strength and elongation at break for wastepaper
pulp/alginate biodegradable films with/without the
crosslinking treatment with CaCl2 solution.

| | | Standard | | |
|---|---|---|---|---|
| | | Deviation of | Elongation | Standard |
| | Tensile | Tensile | at | Deviation for |
| | Strength | Strength | Break | Elongation at |
| Sample ID | (MPa) | (MPa) | (%) | Break (%) |
| SA/PA (1:9) | 1.46 | 0.12 | 1.30 | 0.09 |
| SA/PA (1:9)-Ca | 5.10 | 0.32 | 2.53 | 0.29 |
| SA/PA (2:8) | 2.57 | 0.43 | 1.36 | 0.21 |
| SA/PA (2:8)-Ca | 6.12 | 0.74 | 2.68 | 0.26 |

### Example 9

Water vapor permeability describes a material's ability to allow water vapor to pass through it. It can be seen from Table 2 that the water vapor permeance of wastepaper pulp/alginate mulch film decreases with increasing amount of sodium alginate in the film.

TABLE 2
Water vapor permeance of wastepaper pulp/alginate biodegradable
mulch films after being treated with CaCl₂ solution.

| Sample ID | Water Vapor Permeance (g/24 h · m²) |
|---|---|
| SA/PA (1:9)-Ca | 312.6 |
| SA/PA (2:8)-Ca | 227.4 |

### Example 10

The field test was done in a garden pot with Chives, which was covered by wastepaper pulp/alginate mulch films, as given in FIG. 4. These films could effectively suppress weeds and retain the moisture in the soil in that the required irrigation was reduced by half. The tensile strength of these mulch films was decreased by more than 70% after 5 months. After 3 months, apparent degradation began to occur. The biodegradability can be finely tuned by adjusting the SA/PA composition and degree of crosslinking.

### Example 11

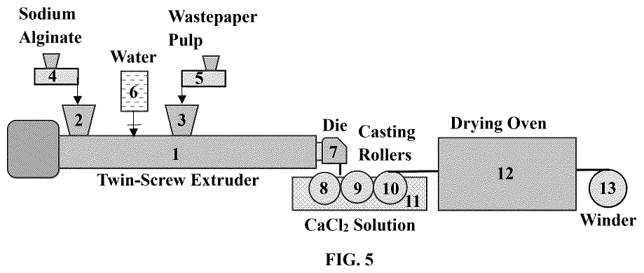

The large-scale manufacturing process for continuously producing wastepaper pulp/calcium alginate biodegradable agricultural mulch film can be done on a twin-screw extruder 1, as schematically illustrated in FIG. 5. Sodium alginate powder is fed through a gravimetrical feeder 4 to a feed hopper 2. Deionized water in a tank 6 is injected into the twin-screw extruder by a metering pump. Under strong shear mixing, sodium alginate is mixed and dissolved with water. After that, wastepaper pulp is added through a gravimetrical feeder 5 to a feed hopper 3, and then mixed with sodium alginate solution. Subsequently, the wastepaper pulp/sodium alginate mixture is pumped through a casting die 7, which shapes the mixture into film. The film is then pulled through casting rollers 8, 9, and 10, and at the same time, the film is dipped into a bath 11 containing CaCl₂) solution for the immediate crosslinking reaction. After that, the film is pulled through a convection drying oven 12 to dry the film. Finally, the film is wound onto a winder 13.

What is claimed is:

1. A composition for making biodegradable agricultural mulch films comprising:
a) a matrix comprising a crosslinking alginate system; and
b) a wastepaper pulp material embedded within said matrix.

2. A biodegradable agricultural mulch film of claim 1, wherein said matrix consists of 5 to 35 weight percent alginate polysaccharides and 65 to 95 weight percent recycled cellulose fibers or wastepaper pulps.

3. The biodegradable agricultural mulch film of claim 1, wherein the recycled cellulose fibers or wastepaper pulps comprise post-consumer waste materials.

4. The composition of claim 1 further comprising a crosslinking agent.

5. The composition of claim 4, wherein said crosslinking agent is selected from the group consisting of bivalent or multivalent ions, such as Ca²⁺, Mg²⁺, Cu²⁺, Ni²⁺, Zn²⁺, Sr²⁺, Ba²⁺, Al³⁺, and Fe³⁺.

6. The biodegradable composition of claim 1 wherein said crosslinking alginate system comprises one or more water-soluble polysaccharides.

7. The biodegradable composition of claim 1 wherein said crosslinking alginate system is selected from the group consisting of water-soluble alginates/algin, chitosan, agar, agarose, aloe mannan, xanthan, hyaluronic acid, pectins, and combinations or derivatives thereof.

8. The biodegradable agricultural mulch film of claim 1, wherein the film is characterized by enhanced mechanical strength and durability.

9. A method of manufacturing biodegradable agricultural mulch films comprising:
a) providing a composite formulation comprising: (i) 65-95 wt % of one or more wastepaper pulp and (ii) 5-35 wt % of alginate polymers crosslinked by bivalent or multivalent ions;
b) forming a hydrogel film from a solution of wastepaper pulp and water-soluble alginate polymer;
c) subjecting the hydrogel film to a solution of 1-50 wt %, preferably 3-10 wt %, bivalent or multivalent ions, followed by drying to remove water; thereby producing a biodegradable agricultural mulch film.

10. The biodegradable composition of claim 9 wherein said crosslinking alginate system comprises one or more water soluble polysaccharides.

11. The biodegradable composition of claim 9 wherein said crosslinking alginate system is selected from the group consisting of water-soluble alginates/algin, chitosan, agar, agarose, aloe mannan, xanthan, hyaluronic acid, pectins, and combinations or derivatives thereof.

12. The composition of claim 9 wherein said crosslinking agent is selected from the group consisting of bivalent or multivalent ions, such as Ca²⁺, Mg²⁺, Cu²⁺, Ni²⁺, Zn²⁺, Sr²⁺, Ba²⁺, Al³⁺, and Fe³⁺.

13. The biodegradable composition of claim 9 wherein said wastepaper pulp material is selected from the group consisting of particulated cellulose fibers from a variety of sources including recycled paper, recycled cellulose fibers, recycled cellulose acetate fibers, coconut husk, sugar beet residues, cotton linters, sawdust, citrus residues, corn stover, cane residues, and/or particulated fibers prepared from coagula or extruded fibers of water-insoluble biopolymers.

14. The biodegradable agricultural mulch film of claim 9, wherein the film is formed using an extrusion process.

15. The method of claim 14, wherein the extrusion process is continuous.

16. The method of claim 14, wherein the mixture of dissolved sodium alginate and recycled cellulose fibers or wastepaper pulps is formed into a film using a die.

17. The method of claim 14, wherein the drying step is conducted in an oven.

18. The method of claim 14, further comprising the step of adjusting the composition ratio of sodium alginate to recycled cellulose fibers or wastepaper pulps to control the properties of the resulting biodegradable agricultural mulch film.

19. The method of claim 14, wherein the biodegradable agricultural mulch films produced exhibit enhanced water resistance and mechanical strength compared to non-crosslinked films.

20. The biodegradable films of claim 14 can be used for packaging and building applications, and the end-life products can be used as a fertilizer for crops and vegetables.
